(19) United States
(12) Patent Application Publication
(10) Pub. No.: US 2018/0075937 A1
(43) Pub. Date: Mar. 15, 2018

(54) DEVICE FOR CONVERTING RADIATION ENERGY TO ELECTRICAL ENERGY

(71) Applicants: Ian Christopher Hamilton, Fort Wayne, IN (US); Nicolette Muldrow, Highland Park, IL (US)

(72) Inventors: Ian Christopher Hamilton, Fort Wayne, IN (US); Nicolette Muldrow, Highland Park, IL (US)

(21) Appl. No.: 15/703,521

(22) Filed: Sep. 13, 2017

Related U.S. Application Data
(60) Provisional application No. 62/393,933, filed on Sep. 13, 2016.

(51) Int. Cl. G21H 1/08; G01T 1/16; H01M 8/0606; H01J 47/02

(52) U.S. Cl. CPC G21H 1/08; H01J 47/02; H01M 8/0606; G01T 1/16

(57) ABSTRACT

A method and device convert radiation energy to electrical energy using an ionizable medium, anode, and cathode.

### CROSS-REFERENCE TO RELATED APPLICATIONS

The present Application claims the benefit of U.S. Provisional Patent Application No. 62/393,933 to Hamilton, entitled “Device for Converting Radiation Energy to Electrical Energy,” and filed on Sep. 13, 2016, which is hereby incorporated by reference in its entirety.

### BACKGROUND AND SUMMARY OF THE PRESENT DISCLOSURE

The present disclosure relates to converting radiation energy to electrical energy.

Exciting a gas results in the ionization of that gas. Ionization causes the separation of positive and negative particles. According to one embodiment of the present disclosure, this separation of positive and negative particles may be used to create electrical energy.

According to one aspect of the present disclosure, a device for converting radiation energy to electrical energy is provided. The device includes a radiation receiving area having an ionizable medium, a cathode positioned to receive charged particles from the ionizable medium resulting from radiation received by the radiation receiving area, an anode to receive charged particles from the ionizable medium resulting from radiation received by the radiation receiving area. The cathode and anode are electrically coupled to provide a flow path for electrical current resulting from the receipt of charged particles by the cathode and anode. The device further includes a photocell positioned to receive light energy from the radiation receiving area.

According to another aspect of the present disclosure, a device for converting radiation energy to electrical energy is provided. The device includes a radiation receiving area having an ionizable medium, a cathode positioned to receive charged particles from the ionizable medium resulting from radiation received by the radiation receiving area. The cathode having a first work function. The device further including an anode to receive charged particles from the ionizable medium resulting from radiation received by the radiation receiving area. The cathode and anode of the device are electrically coupled to provide a flow path for electrical current resulting from the receipt of charged particles by the cathode and anode. The device further includes the anode having a second work function that is different than the first work function.

In yet another aspect of the present disclosure, a device for converting radiation energy to electrical energy is presented. The device includes a radiation receiving area having an ionizable medium, a cathode positioned to receive charged particles from the ionizable medium resulting from radiation received by the radiation receiving area, an anode to receive charged particles from the ionizable medium resulting from radiation received by the radiation receiving area. The cathode and anode are electrically coupled to provide a flow path for electrical current resulting from the receipt of charged particles by the cathode and anode. The device further includes a heat source positioned to heat the ionizable medium.

In another aspect of the present disclosure, a device for converting radiation energy to electrical energy is presented. The device includes a radiation receiving area having an ionizable medium, a cathode positioned to receive charged particles from the ionizable medium resulting from radiation received by the radiation receiving area, and an anode to receive charged particles from the ionizable medium resulting from radiation received by the radiation receiving area. The cathode and anode are electrically coupled to provide a flow path for electrical current resulting from the receipt of charged particles by the cathode and anode. The device further includes that the cathode and the anode are separated by a distance less than the peak wavelength of the blackbody emission spectrum for the material of the cathode and anode.

Additional features of the present invention will become apparent to those skilled in the art upon consideration of the following detailed description of the illustrative embodiment exemplifying the best mode of carrying out the invention as presently perceived. The embodiments of the invention described herein are not intended to be exhaustive or to limit the invention to precise forms disclosed. Rather, the embodiments selected for description have been chosen to enable one skilled in the art to practice the invention.

### BRIEF DESCRIPTION OF THE DRAWINGS

The detailed description of the drawings particularly refers to the accompanying figures in which:

FIG. 1 illustrates schematically a device for converting radiation energy to electrical energy;

FIG. 2 schematically illustrates an additional embodiment of a device for converting radiation energy to electrical energy;

FIG. 3 is a schematically illustrates an additional embodiment of a device for converting radiation energy to electric energy using a photovoltaic cell; and

FIG. 4 illustrates a top view of an array of multiple devices for converting radiation energy to electrical energy.

### DETAILED DESCRIPTION OF THE DRAWINGS

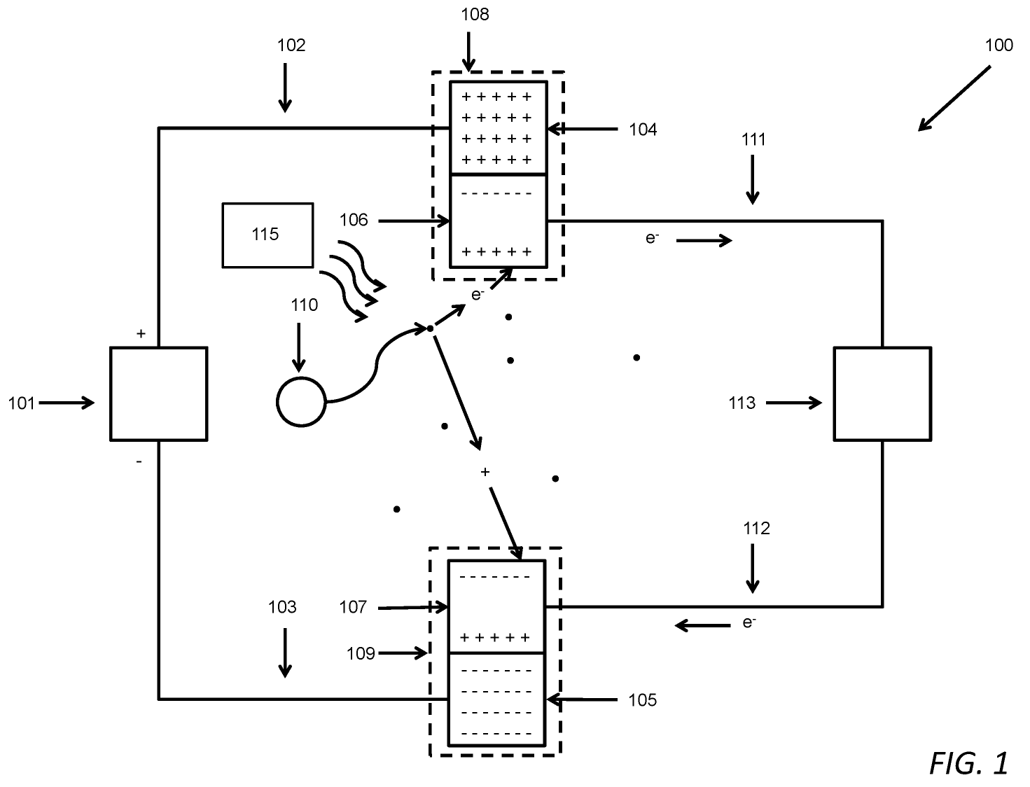

As depicted in FIG. 1, a device 100 for converting radiation energy to electrical energy includes an electrical potential source 101 having a first terminal 102 and a second terminal 103. In one embodiment, the first terminal 102 may comprise a cathode and the second terminal 103 may comprise an anode. In one aspect, the first terminal 102 may comprise leads made of titanium, tungsten, aluminum, iron, nickel, zirconium, uranium, thorium, or other conductive materials. Second terminal 103 may comprise leads made from molybdenum, ytterbium, gadolinium, strontium, iron or other conductive materials. Device 100, depicted in FIG. 1, additionally comprises a first conductive material 104 that is electrically coupled to the first terminal 102, and a second conductive material 105 that is electrically coupled to the second terminal 103. In one aspect, the first conductive material 102 and the second conductive material 103 may comprise a connector plug, which increases the likelihood of insulation of the entire device 100. Furthermore, a third conductive material 106 abuts the first conductive material 104, and a fourth conductive material 107 abuts the second conductive material 105. Together, the first conductive material 104 and the third conductive material 106 constitute a first charged pair 108. Together, the second conductive material 105 and the fourth conductive material 107 constitute a second charged pair 109.

In another aspect, there may be an electrically isolating material positioned between the first conductive material 104 and the third conductive material 106 in order to decrease the likelihood of the depletion of the charge of the first conductive material 104. Similarly, there may be an electrically isolating material positioned between the second conductive material 105 and the fourth conductive material 107 in order to decrease the likelihood of the depletion of the charge of second conductive material 105. In one embodiment, the first, second, third, and fourth conductive materials 104, 105, 106, 107 may comprise aluminum, silver, copper, gold, magnesium, tungsten, nickel, mercury, platinum, iron, and/or graphite.

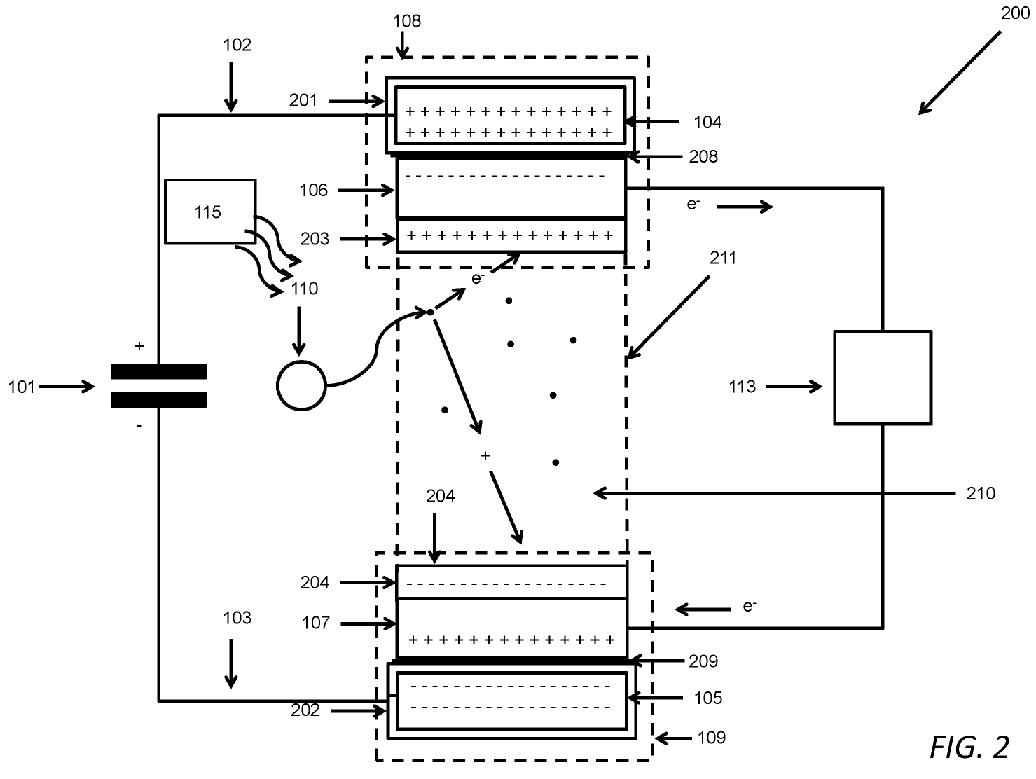

As further depicted in FIG. 1, a radiation source 110 may emit gamma rays. In another aspect, radiation source 110 may be positively charged. Additionally, the third and fourth conductive materials 106, 107 are electrically coupled together though a third terminal 111 and a fourth terminal 112 to create an electrical flow through a load 113, generated by an electrical potential resulting from radiation source 110. Radiation source 110 may comprise lasers, sun light, electromagnetic, heat, nuclear, or other forms of energy transmitting radiation to excite electrons in element molecules. Radiation source 110 causes the excitation of a medium 210 (shown in FIG. 2). In some embodiments, first, second, third, and fourth conductive materials 104, 105, 106, 107 may serve as radiation source 110. Additionally, the device further includes a heat source 115 positioned to heat the ionizable medium. Heat source 115 may comprise lasers, sun light, electromagnetic waves, nuclear, or other forms of energy transmission devices to excite electrons in element molecules. Exciting medium 210 results in its ionization, which causes the separation of positive and negative particles. For example, an atom may lose an electron during ionization. This results in an abundance of electrons on the third conductive material 106 and a collection of protons on the fourth conductive material 107. The net result is a flow of electric current through load 113 from the third conductive material 106 to the fourth conductive material 107. The flow of electric current through load 113 may be measured by an oscilloscope. In certain embodiments, medium 210 is capable to being substantially heated to change the efficiency of the electric potential created through ionization. By increasing the temperature, medium 210 more efficiently transfers electric charge as electrical flow through load 113, generated by an electrical potential resulting from radiation source 110.

Referring to FIG. 2, an alternative embodiment of device 100 is shown as device 200 and includes first, second, third, and fourth conductive materials 104, 105, 106, 107, and electrical potential source 101. Together, the first conductive material 104 and the third conductive material 106 constitute a first charged pair 108. Together, the second conductive material 105 and the fourth conductive material 107 constitute a second charged pair 109. In addition, a first oxide material 201 surrounds the first conductive material 104, and a second oxide material 202 surrounds the second conductive material 105. In some embodiments, the distance between first conductive material 104 and third conductive material 106 and the distance between second conductive material 105 and fourth conductive material 107 may be decreased to within a distance smaller than the emission wavelength of radiation for the blackbody emission spectrum of first and second charged pairs 108, 109. Decreasing the distance between first charged pair 108 and second charged pair 109 provides for near-field enhanced thermal radiation energy transfer between first conductive material 104 and third conductive material 106 and between second conductive material 105 and fourth conductive material 107. In one aspect, the first oxide material 201 and the second oxide material 202 may comprise aluminum oxide. In an alternative embodiment, a first electrically isolating material 208 may be positioned between the first conductive material 104 and the third conductive material 106. A second electrically isolating material 209 may also be positioned between the second conductive material 105 and the fourth conductive material 107. In one embodiment, the first and second electrically isolating materials may comprise electrical insulation paper, acetate, acrylic, beryllium oxide, ceramic, Delrin®, epoxy/fiberglass, glass, Kapton®, Teflon®, Kynar®, Lexan® and Merlon®, melamine, mica, neoprene, Neomex®, polyethylene terephthalate, phenolics, polyester, polyolefins, polystyrene, polyvinylchloride, silicone, thermoplastics, polyurethane, vinyl, laminates, or other electrically isolating materials.

As also depicted in FIG. 2, device 200 may optionally include a first transition metal material 203 abutting the third conductive material 106 and a second transition metal material 204 abutting the fourth conductive material 107. In one aspect, the first transition metal material 203 and the second transition metal material 204 may comprise gold or silver. Furthermore, device 200 as depicted in FIG. 2 may comprise a radiation receiving area 211 separating the third conductive material 106 and the fourth conductive material 107. Radiation receiving area 211 may be included within a housing 216. The radiation receiving area 211 is adapted to receive radiation from the radiation source 110. In one embodiment, the radiation receiving area 211 comprises a noble gas 210 that is positioned within the radiation receiving area 211 that is adapted to receive radiation. In addition, the electrical potential source 101 may be a capacitor or super-capacitor. The capacitor is preferably charged to approximately 800 volts. In another embodiment of the present disclosure, the electrical potential source 101 may be a battery, or another device capable of holding a charge. Additional details of suitable arrangements for converting radiation energy to electrical energy are provided in PCT Patent Application Publication No. US2015/0318065, titled “DEVICE FOR CONVERTING RADIATION ENERGY TO ELECTRICAL ENERGY”, to Ian Hamilton, the entire disclosure of which is expressly incorporated by reference herein.

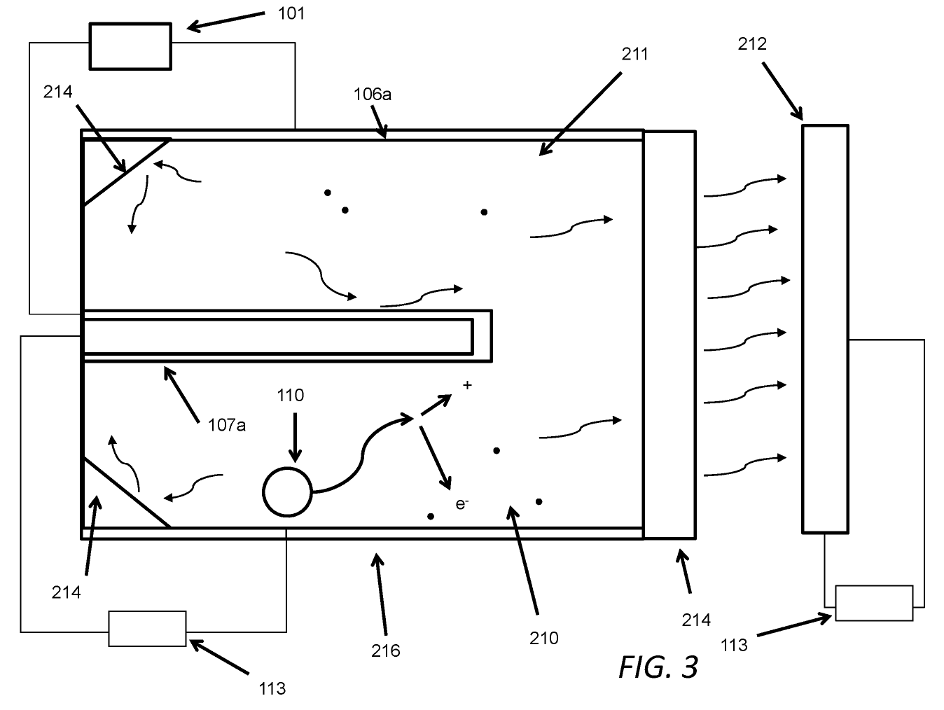

The conversation of radiation energy to electrical energy may be facilitated by introduced additional differences between first and second conductive materials 106, 107. For example, according to the embodiment shown in FIG. 3, the first conductive material is a component of cylindrical outer electrode or collector 106a and the second conductive material is a component of a cylindrical inner electrode or emitter 107a. The inner surface area of outer electrode 106a is substantially larger than the outer surface of inner electrode 107a. Because of the difference in surface area, outer electrode 106a will have a higher rate of collection than inner electrode 107a creating additional electrical potential between first and second conductive materials 106, 107 of first and second electrodes 106a, 107a to drive load 113. The difference in surface area minimizes the potential for buildup of electric potential between first and second conductive materials 106,107. The difference in surface areas between first and second electrodes 106a, 107a may fall within specific ratio ranges larger than 1:1 including: 1:10, 1:40, 1:100, 1:700, or 1:1050, etc. In alternative embodiments, as in FIG. 2, differences discussed herein may be between first conductive material 104 and third conductive material 106, second conductive material 105 and fourth conductive material 107, and between first transition material 202 and second transition material 204 effectuates the same benefit of minimizing the potential for buildup of electric potential. This minimization results in more efficient transfer of electrons in creating an electric potential to drive load 113. Additionally, in one embodiment outer electrode 106a is kept at a low temperature (i.e. as close to absolute zero as possible) and outer electrode 107a is kept at its maximum stable temperature to allow saturation emission current density to maximize the production of electric potential to drive load 113. The temperature for outer electrode 106a may be at least 100 Kelvin. The temperature of inner electrode 107a may be as high as 1000 Kelvin, 2500 Kelvin, 3000 Kelvin, 3600 Kelvin, etc. The temperature of the outer electrode 106(a) may be as cool as 100 Kelvin, 500 Kelvin, 1000 Kelvin, 1050 Kelvin, etc.

In some embodiments, the distance between first and second conductive materials 106, 107 of first and second electrodes 106a, 107a may be decreased to within a distance smaller than the emission wavelength of radiation for the blackbody emission spectrum of first and second electrodes 106a, 107a. Decreasing the distance between first and second electrodes 106a, 107a provides for near-field enhanced thermal radiation energy transfer between first and second electrodes 106a, 107a.

In addition to providing first and second electrodes 106a, 107a, having different surface areas to increase the electrical potential, the work function of the collecting and/or emitting surfaces of first and second electrodes 106a, 107a can be different. Work function differences between first and second electrodes 106a, 107a may differ substantially by a matter of two or three electronvolts or differ minimally within the bounds of differences tolerated by modern manufacturing processes for the materials used to make first and second electrodes 106a, 107a. In some embodiments, first electrode 107a may have a work function ranging from 3 to 5.5 electronvolts. Second electrode 106a may have a work function ranging from 2 to 5 electronvolts. The ratio of the work functions of first electrode 107a to second electrode 106a may be 1:1, 1.5:1, 2.5:1, etc.

By constructing first and second electrodes 106a, 107a of materials having different workfunctions, an electric potential is created between first and second electrodes 106a, 107a when they are exposed to electron-ion pairs as described above in FIGS. 1 and 2. This electrical potential is used to drive load 113. According to one embodiment, first electrode 106a has a lower work function than second electrode 107a.

During the adsorption of energy from radiation source 110, light may be generated within radiation receiving area 211 by the ionization medium or other materials that are present therein. According to the embodiment shown in FIG. 3, a photo cell 212 is provided that converts the generated light into an electrical potential that is applied to load 113. As shown in FIG. 3, reflective surfaces 214 of housing 216 and other components exposed to medium 210 may be provided within and/or around radiation receiving area 211 that direct light 216 toward photo cell 212. Reflective surfaces 214 and these other exposed surfaces may have a reflectance of at least 0.50, 0.75, 0.90, 095, etc. For example, the inner surface of electrode 106a and the outer surface of electrode 107a may be coated with a material that reflects the generated light so the light is not absorbed by electrodes 106a, 107a, but eventually reflected toward photo cell 212 and converted into electrical energy. According to one embodiment, a crystal 214 is provided to lase the light focused on photo cell 212 which is tailored to convert the particular wavelength of light to create an electrical potential. According to another embodiment, no crystal/filter is provided. By capturing and converting the generated light, additional radiation can be converted into electricity.

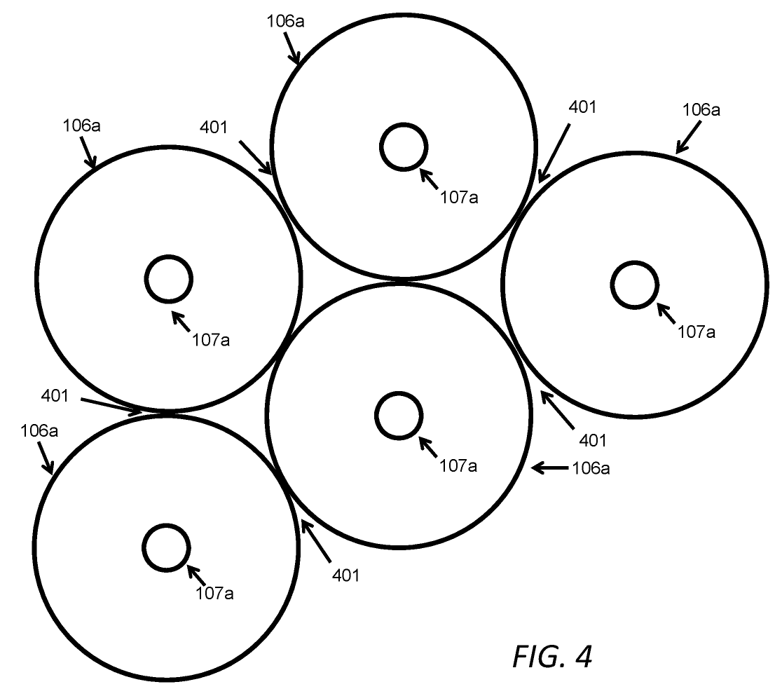

FIG. 4 depicts an array of a cylindrical device embodiment. Each cylinder includes first conductive material as a component of cylindrical outer electrode or collector 106a and second conductive material as a component of a cylindrical inner electrode or emitter 107a. First conductive material as a component of cylindrical outer electrode or collector 106a from each cylindrical device is separated by insulating material 401. Each cylindrical device may be coupled together to drive load 113.

What is claimed is:

1. A device for converting radiation energy to electrical energy including:
a radiation receiving area having an ionizable medium,
a cathode positioned to receive charged particles from the ionizable medium resulting from radiation received by the radiation receiving area,
an anode to receive charged particles from the ionizable medium resulting from radiation received by the radiation receiving area, the cathode and anode being electrically coupled to provide a flow path for electrical current resulting from the receipt of charged particles by the cathode and anode, and
a photocell positioned to receive light energy from the radiation receiving area.

2. The device of claim 1, further comprising a housing defining the radiation receiving area, housing having a reflective surface defining a majority of the surface area of the housing facing the radiation receiving area.

3. (canceled)

4. (canceled)

5. (canceled)

6. The device of claim 2, wherein the reflective surface has a reflectance of at least 0.95.

7. The device of claim 2, wherein the anode and cathodes have reflective surfaces having a reflectance of at least 0.75.

8. The device of claim 2, wherein the reflective surface directs light to the photocell.

9. The device of claim 1, further including a crystal positioned between the radiation receiving area and the photocell.

10. (canceled)

11. The device of claim 1, wherein the cathode includes at least one of titanium, tungsten, silver, aluminum, iron, nickel, zirconium, uranium, or thorium.

12. The device of claim 1, wherein the anode includes at least one of molybdenum, ytterbium, gadolinium, strontium, or iron.

13. The device of claim 1, wherein the ionizable medium is a noble gas.

14. (canceled)

15. (canceled)

16. (canceled)

17. (canceled)

18. The device of claim 1, wherein the cathode is at least 1000 Kelvin.

19. (canceled)

20. (canceled)

21. (canceled)

22. (canceled)

23. The device of claim 1, wherein the anode is less than 1000 Kelvin.

24. (canceled)

25. The device of claim 1, wherein the cathode has a first surface area and the anode has a second surface area, a ratio of the first surface area to the second surface area is at least 1 to 10.

26. (canceled)

27. (canceled)

28. (canceled)

29. (canceled)

30. (canceled)

31. (canceled)

32. A device for converting radiation energy to electrical energy including:
a radiation receiving area having an ionizable medium,
a cathode positioned to receive charged particles from the ionizable medium resulting from radiation received by the radiation receiving area, the cathode having a first work function, and
an anode to receive charged particles from the ionizable medium resulting from radiation received by the radiation receiving area, the cathode and anode being electrically coupled to provide a flow path for electrical current resulting from the receipt of charged particles by the cathode and anode, the anode having a second work function that is different than the first work function.

33. The device of claim 32, wherein a ratio of the first work function to the second work function is at least 1.1 to 1.

34. (canceled)

35. The device of claim 34, wherein a ratio of the first work function to the second work function is at least 2.5 to 1.

36. (canceled)

37. (canceled)

38. (canceled)

39. (canceled)

40. (canceled)

41. A device for converting radiation energy to electrical energy including:
a radiation receiving area having an ionizable medium,
a cathode positioned to receive charged particles from the ionizable medium resulting from radiation received by the radiation receiving area,
an anode to receive charged particles from the ionizable medium resulting from radiation received by the radiation receiving area, the cathode and anode being electrically coupled to provide a flow path for electrical current resulting from the receipt of charged particles by the cathode and anode, and
a heat source positioned to heat the ionizable medium.

42. The device of claim 41, wherein the heat source is a laser.

43. The device of claim 41, wherein the radiation receiving area receives gamma rays from the heat source.

44. The device of claim 41, wherein the heat source is positively charged.

45. The device of claim 41, wherein the radiation receiving area receives radiation from the sun.

46. (canceled)

47. (canceled)

48. (canceled)

49. (canceled)

50. (canceled)

51. (canceled)

52. (canceled)
